(19) United States
(12) Patent Application Publication
(10) Pub. No.: US 2008/0164750 A1
(43) Pub. Date: Jul. 10, 2008

(54) Method For Mounting a Tire to a Wheel Rim and Counterbalacing Weight to be Attached to a Wheel Rim

(76) Inventor: Aldo Vanetta, Ingolstadt (DE)

Correspondence Address: RATNERPRESTIA, P O BOX 980, VALLEY FORGE, PA, 19482-0980, US

(21) Appl. No.: 10/575,008

(22) PCT Filed: Oct. 8, 2004
(86) PCT No.: PCT/DE2004/002243

§ 371 Date: Dec. 20, 2007

(30) Foreign Application Priority Data
Oct. 10, 2003 (DE) 10347800.0

(51) Int. Cl. F16F 15/32

(52) U.S. Cl. 301/5.21

(57) ABSTRACT

The invention relates to a method for mounting a wheel onto a rim, and a corresponding compensating element. The method comprises the following steps: a rim is provided with a specific rim balance error and a specially embodied point which is used to receive a functional element, for example, a valve; a wheel is provided with a specific wheel balance error and a compensating element is provided which is configured in such a manner that it is can be fixed to the point which is used to receive a functional element, such that after mounting on the rim on the point which is used to receive the functional element of the rim, balance error occurs in the drivable state, said balance error lying within a predetermined tolerance range corresponding to the balance error of the wheel. The compensating element is applied to the point which is used to receive the functional element and the wheel is mounted in such a manner that the position of the balance error on the wheel is opposite the point which is used to receive the functional element such that after the wheel has been mounted on the rim, a balance error of the drivable wheel which is below a predetermined threshold value is produced.

The invention relates to a method for mounting a tire to a wheel rim and a counterbalancing weight to be attached to a wheel rim.

The imbalance of a wheel comprising a pneumatic tire being ready for use and mounted at a vehicle should be as small as possible. In addition to the main components wheel rim and tire, there are further elements of a wheel comprising a pneumatic tire being ready for use, namely usually a valve and, nowadays, to an increasing amount a sensor of a tire pressure monitoring system which serves to monitor the tire pressure while the car is in operation.

Without specific measures such tire wheel assembly usually has an imbalance which would render the wheel inappropriate to be used at a motor vehicle. Counterbalancing weights are used to offset such imbalance. For instance, U.S. Pat. No. 5,271,663 A discloses that wheels are usually only balanced after a tire has been mounted to the wheel rim. In such cases, the imbalance of a tire wheel assembly is determined and counterbalancing weights are attached to the circumferential edges of the wheel rim in order to provide balance. In order to reduce the required amount of counterbalancing weights or in order to completely render the subsequent balancing process obsolete, this document suggests to provide wheel rims having a predetermined magnitude of imbalance wherein the magnitude of imbalance corresponds to the average imbalance of a tire. The wheel rims are then marked in order to indicate the position of their largest or lowest weight. In similar ways, tires are marked concerning the position of their imbalance. Upon mounting the tires to the wheel rim, the position of the respective imbalances are taken into account and the mounting is effected such that for a particular combination of a wheel rim and a tire, i.e. for the ready for use tire wheel assembly there is a total imbalance as small as possible. The individual imbalances are therefore counteracting and the remaining total imbalance of the tire wheel assembly is the difference and not the sum of the individual imbalances. It is therefore smaller and can be counterbalanced by a smaller amount of balancing weights. This procedure is called matching.

Matching which completely avoids the necessity to attach additional counterbalancing weights after mounting a tire to a wheel rim is, however, not practical in mass production and has therefore never been implemented on a production scale in the automotive industry. Practical implementation is particularly not possible since it would be too expensive to hold tires and wheel rims having identical or almost identical magnitudes of imbalance at store, to select them then and to mount them in corresponding matching order. WO 92/01918 A1 refers to this fact and suggests that each tire and wheel rim is subjected to measuring in order to determine the value of a parameter which indicates the tendency of the tire to cause vibration, to assign tire and wheel rim a rank designation wherein the rank depends on the magnitude of the parameter, so that each wheel rim and each tire falls into a certain group, and to pair wheels and tires belonging to corresponding groups in such a mutual orientation that the individual imbalances of the tires and the wheels have the tendency to cancel each other.

This method, too, has the disadvantage that it is very elaborate and expensive. Use in mass production as well as for smaller tire dealers, which, after the tire provided by the original equipment has been used have to provide new tires, does therefore seem impractical.

In order to solve this problem, document DE 102 28 164 C1 suggests that upon production of a wheel the elimination of an imbalance or the provision of a predetermined magnitude of imbalance, respectively, for the wheel rim should be effected in a specific manner, namely such that a subsequent balancing of the total imbalance resulting from the combination of this wheel rim with a tire can be effected as simple as possible. As to this, a wheel rim is provided having a specific balancing machining section and is mounted to a balancing device on which the imbalance of the wheel rim is determined with respect to its position and its magnitude. Then, a depression of a predetermined form is produced in this balancing machining section of the wheel rim by mechanical machining, wherein the position, the number and the dimensions of the depression are selected such that the magnitude of imbalance of the wheel rim after production of at least one depression is within a predetermined range of tolerance around a predetermined target value. The form of the depression is always selected such that the depression, in a later process of mounting a tire classified with respect to the position and magnitude of its imbalance to the wheel rim can accommodate a counterbalancing weight corresponding to the form of the depression in order to compensate the imbalance of the ready mounted wheel.

This method takes account of the fact that during the process of production of a tire measuring the magnitude of imbalance for quality control is necessary anyway so that providing a mark indicating the position and magnitude of imbalance does not lead to an unacceptably high operating expense while the elimination of an imbalance of a tire, specifically in mass production, is not practicable. Furthermore, it is taken into account that during the process of production of a wheel rim not only measuring of the magnitude of imbalance but also elimination of an imbalance is comparatively simply due to the fact that machining is necessary anyway.

Accordingly, this known concept provides a method for assembling a wheel wherein a wheel rim is provided, the magnitude of imbalance of which lies within a predetermined tolerance range around a predetermined target value, wherein the wheel rim has a depression having a predetermined form, namely the machined area mentioned above lying within the balancing machining section. A tire having a specific tire imbalance which has a tire marking which allows to determine the position and magnitude of tire imbalance is also provided for the assembling process. A counterbalancing weight corresponding to the predetermined form of the depression for eliminating the imbalance of the wheel rim/tire assembly is selected taking account of this tire and is mounted in the depression. Subsequently, the tire is mounted to the wheel rim in such a position with respect to the wheel rim that after mounting the tire to the wheel rim the magnitude of an imbalance of the ready mounted wheel is below a predetermined threshold value.

The object underlying the present invention is to further simplify the method for mounting a tire on a wheel rim known from DE 102 28 164 C1 and to provide a corresponding counterbalancing weight element to be attached to a wheel rim.

The solution to this object is given in claims 1 and 20. Preferred embodiments of the invention are defined in the subclaims.

The method for mounting a tire to a wheel rim according to the present invention firstly comprises the step according to which a wheel rim having a predetermined wheel rim imbalance and having a location specifically designed for accommodating a functional element is provided.

Such functional element is for instance a valve or a sensor or any other element of a tire pressure monitoring system. The specifically designed location for accommodating a functional element can therefore be for instance the hole in the wheel rim for accommodating a valve or a location specifically designed for mounting a sensor or any other element of a tire pressure monitoring system to the wheel rim.

The magnitude of the imbalance of the wheel rim lies within a predetermined tolerance range around a predetermined target value at a spot of the wheel rim which is positioned opposite to the location specifically designed to receive a functional element, for instance opposite to the bore for accommodating a valve.

As the next method step, a tire having a specific tire imbalance is provided which tire has a tire marking serving to recognize the position and magnitude of the tire imbalance. Moreover, a counterbalancing weight element is provided which is designed such that it can be mounted at the location specifically designed to receive a functional element, namely for instance at the bore of the wheel rim for accommodating a valve. The counterbalancing weight element is selected such that, after it has been attached to the wheel rim at said location, it provides the wheel rim in a ready mounted condition an imbalance of a magnitude which is within the predetermined range of tolerance of the imbalance of the tire.

This counterbalancing weight element is attached to the specifically designed location for accommodating a functional element, namely for instance at the bore of the wheel rim for accommodating a valve, and the tire is mounted to the wheel rim in such a position with respect to the wheel rim that the position of the imbalance of the tire lies opposite to the location specifically designed for accommodating a functional element, namely for instance opposite to the valve bore of the wheel rim. This results in that after mounting of the tire to the wheel rim the magnitude of the imbalance of the ready mounted wheel is below a predetermined threshold value.

Likewise as according to the method known from DE 102 28 164 C1, a wheel rim is therefore prepared in such a way that later, namely prior to the mounting of a tire to the wheel rim, a counterbalancing weight element can be selected and attached to the wheel rim which counterbalancing weight element has the effect that the tire/wheel assembly ready for use is balanced as perfectly as possible, i.e. that the magnitude of the imbalance of the ready mounted wheel is almost zero. It is understood for a person skilled in the art that in this connection all components of the ready mounted wheel including the valve and sensors and other elements of a tire pressure monitoring system have to be taken into account. Therefore, according to the present invention a specific valve type and, as the case may be, elements of a tire pressure monitoring system which can have a specific standard mass are already taken into account upon production of a wheel rim.

This means that the wheel rim taken alone has such an imbalance that, after mounting of all components like for instance the valve and sensors or other elements of a tire pressure monitoring system, the wheel rim is practically completely balanced. Prior to mounting the tire, the only thing left to do to the otherwise ready mounted wheel is therefore only to attach a counterbalancing weight element corresponding to the imbalance of the tire to the wheel rim, or, instead of one of the mentioned functional elements having a standard mass, such a functional element which has a mass increased by the required mass of the counterbalancing weight element.

Other than in case of the method known from DE 102 28 164 C1, when using the method according to the present invention no additional depression has to be prepared in the balancing machining section of the wheel rim in order to attach a counterbalancing weight element because attachment of the counterbalancing weight element is effected at the specifically designed location for accommodating a functional element, namely for instance the bore for accommodating the valve. In other words, the attachment of the counterbalancing weight is effected at a location which has to be machined anyway for accommodating a functional element. Moreover, machining of the wheel rim in the area in which usually counterbalancing weights are attached can be effected without further requirements concerning provision of a balancing machining section. This decreases the required work in general.

According to one embodiment of the invention, the counterbalancing weight element can be screwed to the valve by use of a hollow-core screw. Accordingly, the valve has to comprise a corresponding threaded hole. In case that instead of metal valves which can be provided with a threaded hole without any problems rubber valves should be used, it is suggested that preferably a threaded bushing is provided. It is further possible that a counterbalancing weight element is attached either at the valve or at a sensor of a tire pressure monitoring system. Alternatively, it is possible that the before-mentioned functional elements are provided in variable sizes so that the counterbalancing weight element does not need to be attached separately but can be formed as an integral part of the valve or the sensor, respectively.

According to a further embodiment of the invention, a bracket or clip, preferably made of metal, can be attached to the valve. This clip can be used as a fastening element for the counterbalancing weight element. If for instance a wheel rim having all functional elements including the before-mentioned clip is provided such that it is practically fully balanced, it would only be necessary to attach a counterbalancing weight element corresponding to the magnitude of imbalance of the tire to the clip prior to mounting the said tire in order to ensure that after mounting of the tire the total magnitude of imbalance of the ready mounted wheel is below a predetermined threshold value. Such embodiment provides the advantage that upon replacement of the tire only the counterbalancing weight element has to be removed, i.e. detached from the clip, and a new counterbalancing weight element corresponding to the magnitude of the imbalance of the newly mounted tire has to be attached.

A person skilled in the art has various options to attach the counterbalancing weight element at a location for accommodating a functional element. The attachment can be effected directly at the mentioned location of the wheel rim or via appropriate connecting means like screws, e.g. a hollow-core screw, or a clip connection to the respective functional element. Moreover, the counterbalancing weight element can be an integral part of the respective functional element, for instance by providing valves or sensors in different weight classes or as sensors without function, so-called dummies, in various weight classes.

In principle, the counterbalancing weight elements can be made from any material. Preferably, a metal, particularly steel is used. Based on the method of attachment and particularly due to the place of attachment, namely at the inner side of the wheel rim, there is no need to use heavy metals to provide a mass as high as possible at a volume as small as possible, for instance lead, since such heavy metals are little environment friendly or not environment friendly at all.

The invention is further explained in the following with reference to preferred embodiments in connection with the drawing, in which

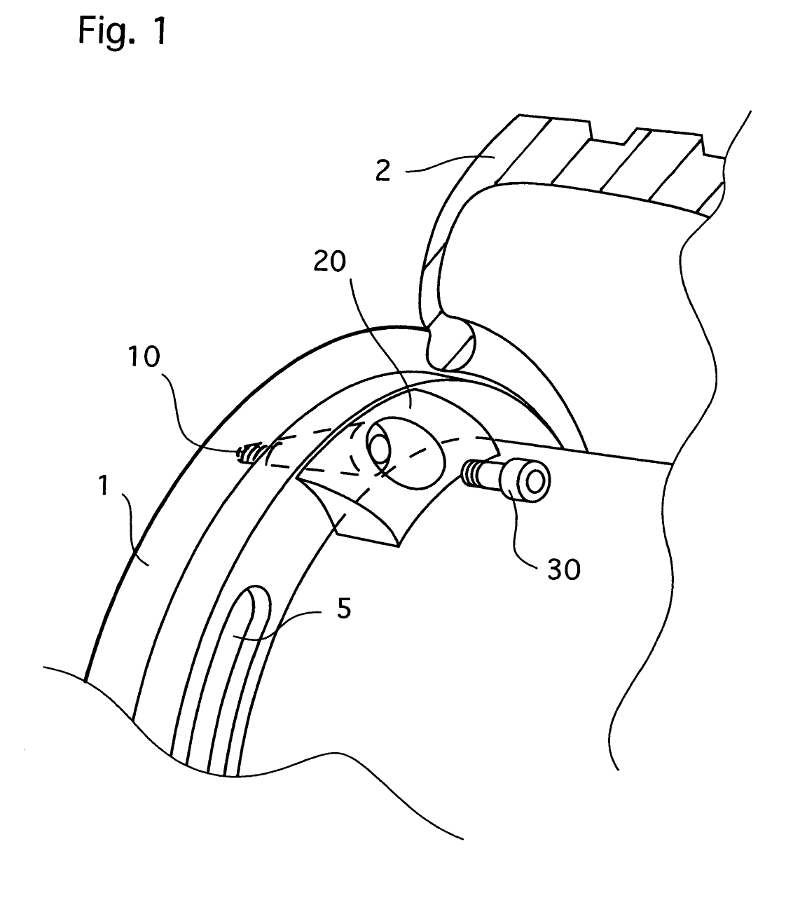

FIG. 1 is a perspective, partially cut away view illustrating a wheel;

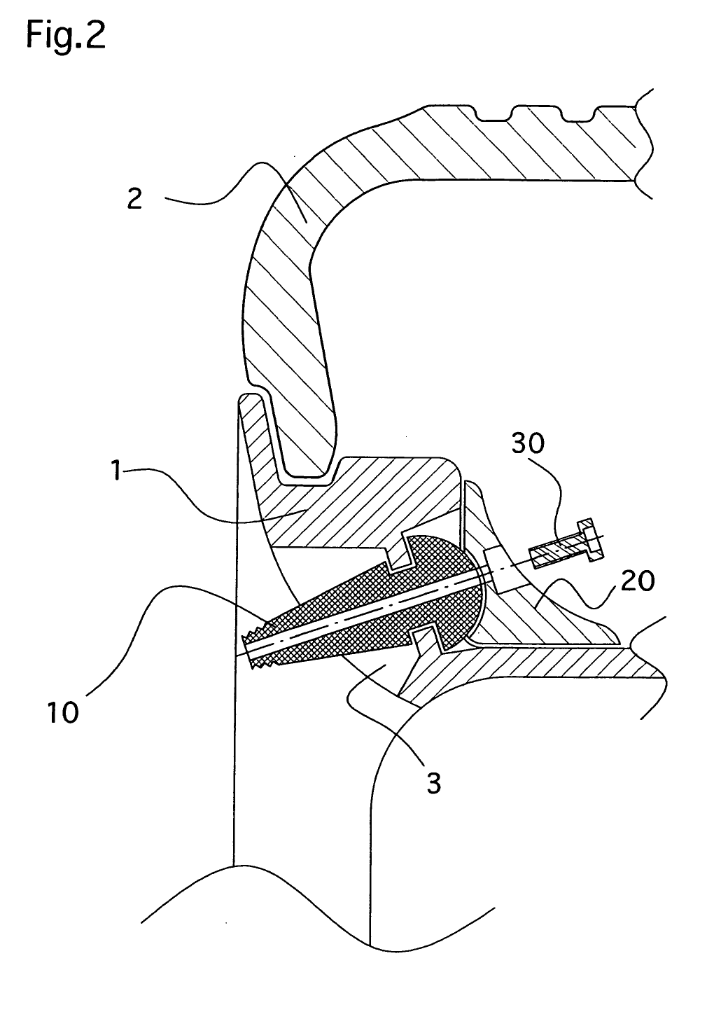

FIG. 2 is a sectional view of the wheel according to FIG. 1;

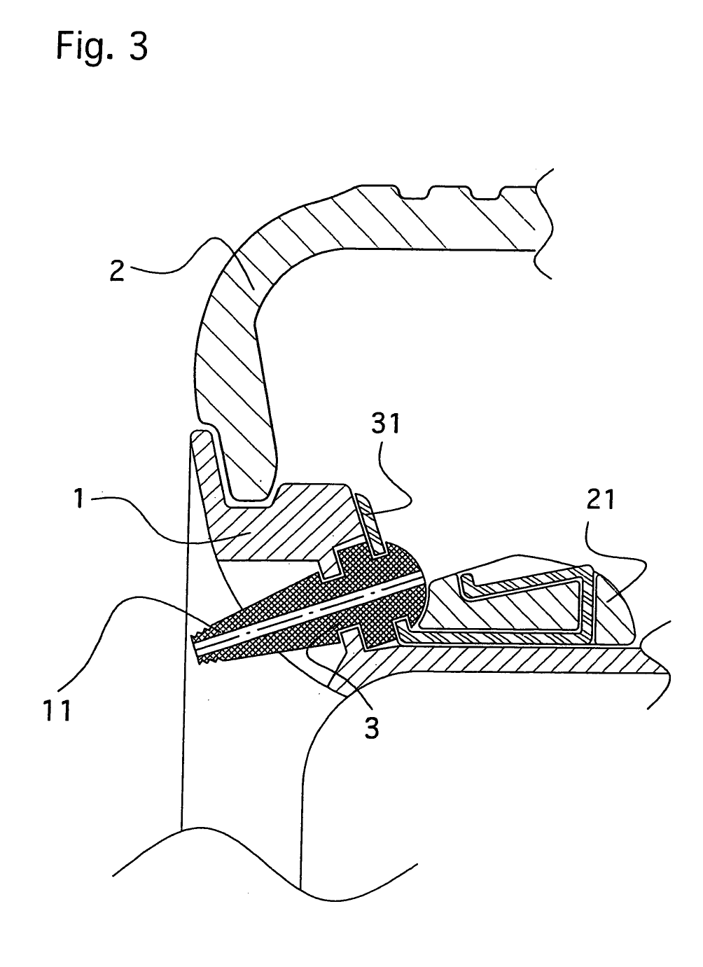

FIG. 3 is a sectional view of a portion of a wheel rim in the area of the valve and associated components; and

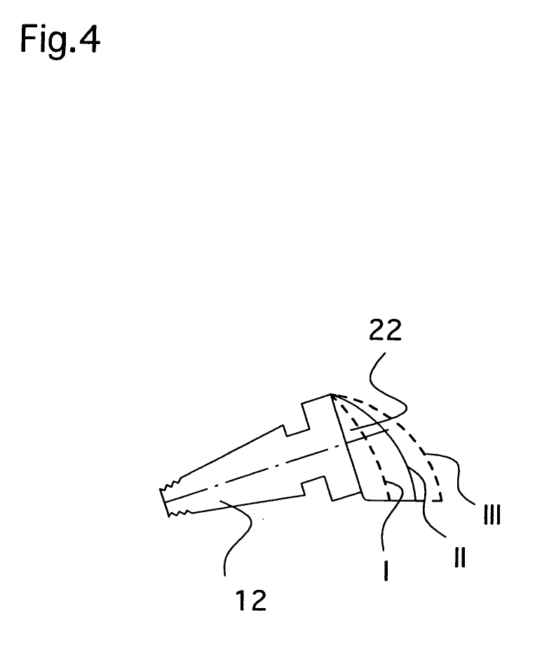

FIG. 4 shows an embodiment of a valve.

FIG. 1 shows schematically a segment of a wheel rim 1 on which a tire 2 is mounted. A valve 10 is provided in a valve bore 3 shown in more detail in FIG. 2. A counterbalancing weight element 20 is attached to the valve 10 and screwed to it via a hollow-core screw 30. Moreover, a machined surface 5 is shown in the area of the wheel rim hump in FIG. 1.

The valve 10 represents a functional element in the meaning of the invention. The valve bore 3 represents a location for accommodating a functional element in the meaning of the invention.

A further functional element in the meaning of the invention can for instance be the sensor of a tire pressure monitoring system (not shown).

Wheel rim 1 as such, i.e. without any further elements like valve, tire, etc. is produced such that it has an imbalance being situated opposite to the valve bore 3 and having a magnitude which is within a predetermined range of tolerance around a predetermined target value. This target value corresponds to the weight of the valve 10 and the screw 30. If necessary, machining can be effected to a corresponding amount and at a suitable position of the wheel rim 1, for instance at the location indicated at 5 in order to provide a target imbalance.

The before-mentioned target imbalance is determined such that the wheel rim 1, when provided with the valve 10 and, accordingly, is ready to use except from mounting the tire 2, comprises an imbalance which has a magnitude within a predetermined range of tolerance around the value zero. In other words, the wheel rim is manufactured such that it is practically without any imbalance when all functional elements are mounted.

The tire 2 is classified with respect to the position and magnitude of its imbalance. It has a marking or indication from which the position and magnitude of the tire imbalance can be recognized. For instance, if the tire 2 has an imbalance of 30 gram, related to the radius of the wheel rim hump in the area of the valve bore 3, a counterbalancing weight element 20 is selected which also has a weight of 30 gram. This counterbalancing weight element 20 is screwed to the valve 10 via the hollow-core screw 30. Subsequently, the tire 2 is mounted to the wheel rim 1 such that its imbalance of 30 gram is situated opposite to the valve bore. Thereby, the imbalance of the tire 2 and the imbalance of the wheel 1 caused by the counterbalance weight element 20 cancel each other so that a ready to use wheel is provided which is perfectly balanced within predetermined threshold values of tolerance.

FIG. 3 shows an alternative embodiment of a counterbalancing weight element 21 which is attached to a correspondingly designed valve 11 being inserted in the valve bore 3 of the wheel rim 1 by means of a clip 31.

FIG. 4 shows a valve 12 wherein the counterbalancing weight element 22 is attached such that it forms an integral part made from the same material. As shown by the solid line II and the possible alternative outer lines I and III indicated as broken lines, it can be seen that an upper part of the valve 12 only provided for weight reasons can be made in various dimensions in order to provide an imbalance compensation in the meaning of the invention.

1. A method for mounting a tire to a wheel rim comprising the following steps:
a) Providing a wheel rim having a predetermined wheel rim imbalance and having a specifically designed location for accommodating a functional element, wherein the magnitude of imbalance of the wheel rim is within a predetermined tolerance range around a predetermined target value at a position of the wheel rim which lies opposite to the location for accommodating a functional element;
b) providing a tire having a predetermined tire imbalance, the tire having a tire marking such that the position and magnitude of the tire imbalance can be recognized from it;
c) providing a counterbalancing weight element which is designed such that it can be attached at the location for accommodating the functional element and which is designed such that, after having been attached to the wheel rim at the location for accommodating the functional element provides the wheel rim in a ready-to-use condition with an imbalance of a magnitude, within a predetermined tolerance range, which corresponds to the imbalance of the tired; and
d) attaching the counterbalancing weight element at the location for accommodating the functional element and mounting the tire to the wheel rim in such a positional relation with respect to the wheel rim that the position of the imbalance of the tire flies opposite to the location for accommodating a functional element so that after mounting of the tire to the wheel rim the magnitude of imbalance of the wheel ready to be driven is below a predetermined threshold value.

2. The method according to claim 1, wherein the location for accommodating the functional element is a bore for accommodating a valve.

3. The method according to claim 2, wherein the counterbalancing weight element is attached to the valve bore via screwed fastening.

4. The method according to claim 3, wherein a hollow-core screw is used to attach the counterbalancing weight element to the valve bore.

5. The method according to claim 2, wherein the counterbalancing weight element is screwed to the valve.

6. The method according to claim 2, wherein the counterbalancing weight element is integrally attached to the valve.

7. The method according to claim 2, wherein the counterbalancing weight element is attached to the valve bore via a clip connection.

8. The method according to claim 7, wherein the clip connection for attaching the counterbalancing weight element to the valve bore also serves to fix the valve to the valve bore.

9. The method according to claim 2, wherein the fastening of the counterbalancing weight element to the valve bore is effected in functional unity with the fastening of a sensor element of a tire pressure monitoring system.

10. The method according to claim 1, wherein the location for accommodating the functional element is the location where a sensor element of a tire pressure monitoring system is attached.

11. The method according to claim 10, wherein the counterbalancing weight element is attached to the sensor element of the tire pressure monitoring system.

12. The method according to claim 11, wherein the counterbalancing weight element is integrally formed with the sensor element of the tire pressure monitoring system.

13. The method according to claim 10, wherein the sensor element of the tire pressure monitoring system does not have a function and is designed as a dummy.

14. The method according to claim 1, wherein the predetermined target value is selected such that the magnitude of the total imbalance of the wheel rim is zero if the valve is mounted in a ready for use condition.

15. The method according to any of claim 1, wherein the predetermined target value is selected such that the magnitude of the total imbalance of the wheel rim is zero if the valve and the sensor of the tire pressure monitoring system are mounted in a ready-to-use condition.

16. The method according to claim 1, wherein the predetermined tolerance range around the target value is ≦±10 g, preferably ≦±5 g and most preferably ≦±2 g.

17. The method according to any of claim 1, wherein the predetermined threshold value is ≦±10 g.

18. The method according to claim 17, wherein the predetermined threshold value is ≦5 g.

19. The method according to claim 1, wherein a bore for accommodating a valve is provided in a hump of the wheel rim.

20. A counterbalancing weight element to be attached to a wheel rim having a location for accommodating a functional element wherein due to a counterbalancing weight element after mounting a tire to the wheel rim the imbalance of a wheel ready to use has a magnitude below a predetermined threshold value,
and wherein said counterbalancing weight element is adapted to be mounted at the location for accommodating a functional element.

21. The counterbalancing weight element according to claim 20, wherein the location for accommodating a functional element is a bore for accommodating a valve.

22. The counterbalancing weight element according to claim 21, wherein it is adapted to be attached to the valve bore via screwed fastening.

23. The counterbalancing weight element according to claim 22, wherein it is adapted to be attached to the valve bore via a hollow-core screw.

24. The counterbalancing weight element according to claim 21, wherein it is adapted to be screwed to a valve inserted in a valve bore.

25. The counterbalancing weight element according to claim 21, wherein it is integrally formed at a valve being adapted to be inserted in the valve bore.

26. The counterbalancing weight element according to claim 21, wherein it is adapted to be fastened to a valve bore via a clip connection.

27. The counterbalancing weight element according to claim 26, wherein the clip connection for fastening the counterbalancing weight element to the valve bore also serves to fix the valve in the valve bore.

28. The counterbalancing weight element according to claim 21, wherein it is adapted to be attached to a valve bore in functional unity with the fastening of a sensor element of a tire pressure monitoring system.

29. The counterbalancing weight element according to claim 20, wherein the location for accommodating a functional element is the area where a sensor element of a tire pressure monitoring system is attached.

30. The counterbalancing weight element according to claim 29, wherein it is adapted to be attached to the sensor element of a tire pressure monitoring system.

31. The counterbalancing weight element according to claim 30, wherein it is formed integrally with the sensor element of a tire pressure monitoring system.

32. The counterbalancing weight element according to claim 29, wherein the sensor element of the tire pressure monitoring system has no function and is designed as a dummy.
